(19) United States
(12) Patent Application Publication
(10) Pub. No.: US 2014/0300522 A1
(43) Pub. Date: Oct. 9, 2014

(54) COIL ANTENNA, COIL ANTENNA-MOUNTED STRUCTURE, COIL ANTENNA MANUFACTURING METHOD, COIL ANTENNA-MOUNTED STRUCTURE MANUFACTURING METHOD

(71) Applicants: Shinjiro Kato, Hyogo (JP); Shinichi Kojima, Hyogo (JP); Tatsuya Fujii, Kanagawa (JP)

(72) Inventors: Shinjiro Kato, Hyogo (JP); Shinichi Kojima, Hyogo (JP); Tatsuya Fujii, Kanagawa (JP)

(73) Assignee: RICOH COMPANY LTD., Tokyo (JP)

(21) Appl. No.: 14/355,712

(22) PCT Filed: Oct. 23, 2012
(86) PCT No.: PCT/JP2012/077819

§ 371 Date: May 1, 2014

(30) Foreign Application Priority Data
Nov. 4, 2011 (JP) 2011-242592

(51) Int. Cl. H01Q 7/06

(52) U.S. Cl. CPC H01Q 7/06
USPC 343/788; 29/600

(57) ABSTRACT

A coil antenna has a core that is plate-shaped and includes a magnetic material; a coil wire that is wound around the core; a first insulating layer that is arranged on a surface of the core, the insulating layer being arranged to cover the coil wire and have a flat surface opposite the core; a second insulating layer that is arranged on a rear face opposite the surface of the core, the second insulating layer being arranged to cover the coil wire and to have a flat surface opposite the core; a flat first metal layer arranged on the flat surface of the first insulating layer; and a flat second metal layer arranged on the flat surface of the second insulating layer.

### TECHNICAL FIELD

The disclosures herein generally relate to a coil antenna, a coil antenna-mounted structure, a coil antenna manufacturing method, and a coil antenna-mounted structure manufacturing method, and particularly to a coil antenna having a plate-shaped core including a magnetic material and a coil wire that is wound around the plate-shaped core.

### BACKGROUND ART

A coil antenna having a coil wire wound around a magnetic material may be used in a non-contact information recording medium such as an integrated circuit (IC) card, a radio frequency identification (RFI) tag, a subscriber identity module (SIM) card, or a micro secure digital (SD) card.

A non-contact information recording medium is prone to influences from metallic surfaces located in the surrounding environment and may suffer from communication property degradation. Japanese Laid-Open Patent Application No. 2009-130446 discloses technology for maintaining the communication property of a coil antenna by interposing the coil antenna between two metal plates.

FIG. 1 is a schematic side view of an exemplary coil antenna. In FIG. 1, a coil antenna 101 includes a magnetic plate core 103, a coil wire 105, adhesive layers 107a, 107b, and metal foils 109a, 109b.

The coil wire 105 is wound around Ore 103. The metal foil 109a is arranged on one surface 103a of the core 103 via the adhesive layer 107a. The metal foil 109b is arranged on a rear face 103b of the core 103 via the adhesive layer 107b.

In FIG. 1, the foil 109a may be warped and uneven due to the concavo-convex surface created by the coil wire 105 arranged on the surface 103a. Similarly, the metal foil 109b may be warped and uneven due to the concavo-convex surface created by the coil wire 105 arranged on the rear face 103b. Such warping and unevenness of the metal foils 109a and 109b may lead to a decrease in the communication distance of the coil antenna 101.

### DISCLOSURE OF THE INVENTION

### Problems to be Solved by the Invention

It is a general object of at least one embodiment of the present invention to provide a coil antenna that substantially obviates one or more problems caused by the limitations and disadvantages of the related art.

### Means for Solving the Problems

According to one aspect of the present invention, a coil antenna-mounted structure includes a coil antenna having a core that is plate-shaped and includes a magnetic material and a coil wire that is wound around the core; and a mounting substrate on which the coil antenna is mounted; wherein the coil antenna includes an insulating layer having a flat surface and a flat metal layer that is arranged on the flat surface of the insulating layer, the insulating layer being arranged on a surface of the core opposite the mounting substrate to cover the coil wire; and the mounting substrate includes a flat metal layer antenna pattern that is arranged at a location facing the coil antenna.

According to another aspect of the present invention, a coil antenna includes a core that is plate-shaped and includes a magnetic material; a coil wire that is wound around the core; a first insulating layer that is arranged on a surface of the core, the insulating layer being arranged to cover the coil wire and have a flat surface opposite the core; a second insulating layer that is arranged on a rear face opposite the surface of the core, the second insulating layer being arranged to cover the coil wire and to have a flat surface opposite the core; a flat first metal layer arranged on the flat surface of the first insulating layer; and a flat second metal layer arranged on the flat surface of the second insulating layer.

According to another aspect of the present embodiment, a method of manufacturing a coil antenna having a core that is plate-shaped and includes magnetic material and a coil wire that is wound around the core is provided, the method including the steps of arranging an insulating layer on a surface of the core, the insulating layer being arranged to cover the coil wire and to have a flat surface opposite the surface of the core; and arranging a flat metal layer on the flat surface of the insulating layer.

According to another aspect of the present invention, a method of manufacturing a coil antenna having a core that is plate-shaped and includes a magnetic material and a coil wire that is wound around the core is provided, the method including the steps of dropping a predetermined amount of insulating adhesive on a surface of the core; and arranging a metal layer having a substantially uniform thickness on the insulating adhesive, pressing the metal layer towards the core using a press member having a flat surface that is parallel to the surface of the core, creating an insulating layer from the insulating adhesive by arranging the insulating adhesive on the surface of the core to cover the coil wire and have a flat surface opposite the core, and arranging the flat metal layer to be flat on the flat surface of the insulating layer.

According to another aspect of the present invention, a method of manufacturing a coil antenna-mounted structure is provided, the method including the steps of arranging a coil antenna having a core that is plate-shaped and includes a magnetic material, a coil wire that is wound around the core, an insulating layer having a flat surface and a flat metal layer that is arranged on the flat surface of the insulating layer, the insulating layer being arranged on a surface of the core to cover the coil wire; and mounting the coil antenna on a mounting substrate, the mounting substrate having a metal layer antenna pattern arranged at a mounting location of the coil antenna; wherein the metal layer antenna pattern is arranged to face a rear face of the core opposite the surface on which the flat metal layer is arranged.

### Effects of the Present Invention

According to one aspect of the present invention, a coil antenna-mounted structure includes a coil antenna having a flat metal layer arranged on a flat surface of an insulating layer and a mounting substrate having a flat metal layer antenna pattern arranged at a position facing the coil antenna. In this way, the communication distance of the coil antenna may be improved compared to a coil antenna having a metal layer that is warped and/or uneven.

Further, by using a flat metal layer antenna pattern arranged on the mounting substrate as one of the metal layers of a coil antenna-mounted structure having a core interposed between two flat metal layers, the process of manufacturing the coil antenna-mounted structure may be simplified and the manufacturing cost may be reduced.

According to another aspect of the present invention, a coil antenna includes a flat first metal layer and a flat second metal layer arranged on the flat surfaces of a first insulating layer and a second insulating layer that are arranged on a surface and a rear face of the core. In this way, the communication distance of the coil antenna may be improved compared to a coil antenna having metal layers that are warped and/or uneven.

Further, by arranging the flat first metal layer and the flat second metal layer on the core beforehand, the mounting process may be simplified and deviations in the coil antenna performance may be prevented so that mass production of the coil antenna may be possible.

According to another aspect of the present invention, a method of manufacturing a coil antenna includes the steps of arranging an insulating layer on a surface of the core, the insulating layer being arranged to cover the coil wire and to have a flat surface opposite the surface of the core; and arranging a flat metal layer on the flat surface of the insulating layer. In this way, a flat metal layer may be arranged on the surface of the core so that the communication distance of the coil antenna may be improved compared to a coil antenna having a metal layer that is warped and/or uneven.

According to another aspect of the present invention, a method of manufacturing a coil antenna includes the steps of dropping a predetermined amount of insulating adhesive on a surface of the core; and arranging a metal layer having a substantially uniform thickness on the insulating adhesive, pressing the metal layer towards the core using a press member having a flat surface that is parallel to the surface of the core, creating an insulating layer from the insulating adhesive by arranging the insulating adhesive on the surface of the core to cover the coil wire and have a flat surface opposite the core, and arranging the flat metal layer to be flat on the flat surface of the insulating layer. In this way, a flat metal layer may be arranged on the surface of the core so that the communication distance of the coil antenna may be improved compared to a coil antenna having a metal layer that is warped and/or uneven.

According to another aspect of the present invention, a method of manufacturing a coil antenna-mounted structure includes the steps of arranging a coil antenna having a core that is plate-shaped and includes a magnetic material, a coil wire that is wound around the core, an insulating layer having a flat surface and a flat metal layer that is arranged on the flat surface of the insulating layer, the insulating layer being arranged on a surface of the core to cover the coil wire; and mounting the coil antenna on a mounting substrate, the mounting substrate having a metal layer antenna pattern arranged at a mounting location of the coil antenna; wherein the metal layer antenna pattern is arranged to face a rear face of the core opposite the surface on which the flat metal layer is arranged. In this way, a coil antenna-mounted structure having a core and a coil wire interposed between a flat metal layer and a flat metal layer antenna pattern may be created so that the communication distance of the coil antenna may be improved compared to a coil antenna having a metal layer that is warped and/or uneven.

Further, by using a flat metal layer antenna pattern arranged on the mounting substrate as one of the metal layers of a coil antenna-mounted structure having a core interposed between two flat metal layers, the process of manufacturing the coil antenna-mounted structure may be simplified and the manufacturing cost may be reduced.

### BRIEF DESCRIPTION OF THE DRAWINGS

FIG. 1 is a schematic side view of an exemplary coil antenna;

FIGS. 2A-2D are a front view, a top view, a rear view, and a right side view of a coil antenna according to an embodiment of the present invention;

FIG. 3 is a diagram schematically illustrating a method of measuring the communication distance of a coil antenna;

FIGS. 4A and 4B are a top view and a front view of a coil antenna-mounted structure according to an embodiment of the present invention;

FIGS. 5A-5D are a front view, a top view, a rear view, and a right side view of a coil antenna used in the coil antenna-mounted structure of FIGS. 4A and 4B;

FIGS. 6A and 6B are a top view and a cross-sectional view of a mounting substrate used in the coil antenna-mounted structure of FIGS. 4A and 4B;

FIGS. 7A and 7B are a top view and a front view of a coil antenna-mounted structure according to another embodiment of the present invention;

FIGS. 8A-8D are a front view, a top view, a rear view, and a right side view of a coil antenna used in the coil antenna-mounted structure of FIGS. 7A and 7B;

FIGS. 9A and 9B are a top view and a front view of a coil antenna-mounted structure according to another embodiment of the present invention;

FIGS. 10A and 10B are a top view and a front view of a coil antenna-mounted structure according to another embodiment of the present invention;

FIGS. 11A and 11B are a top view and a front view of a coil antenna-mounted structure according to another embodiment of the present invention;

FIGS. 12A and 12B are a top view and a cross-sectional view of a mounting substrate used in the coil antenna-mounted structure of FIGS. 11A and 11B;

FIGS. 13A-13C are schematic side views illustrating exemplary process steps for manufacturing a coil antenna according to an embodiment of the present invention;

FIG. 14 is a perspective view of an exemplary jig for transporting a metal layer that is used in the process step of FIG. 13C;

FIGS. 15A-15E are a perspective view and side views illustrating exemplary process steps for manufacturing a coil antenna according to another embodiment of the present invention;

FIGS. 16A-16C are schematic side views illustrating exemplary process steps for manufacturing a coil antenna according to another embodiment of the present invention;

FIGS. 17A-17C are schematic side views illustrating exemplary process steps for manufacturing a coil antenna according to another embodiment of the present invention; and

FIGS. 18A and 18B are a front view and a bottom view of a porous nozzle of a dispenser used in the process step of FIG. 17A.

### DESCRIPTION OF THE REFERENCE NUMERALS

1: COIL ANTENNA
3: CORE
5: COIL WIRE
7a: INSULATING LAYER (FIRST INSULATING LAYER)
7b: INSULATING LAYER (SECOND INSULATING LAYER)
9a: METAL LAYER (FIRST METAL LAYER)
9b: METAL LAYER (SECOND METAL LAYER)
11, 13: COIL ANTENNA TERMINAL
15: COIL ANTENNA
17: MOUNTING SUBSTRATE
19: INSULATING BASE MATERIAL
21: METAL LAYER ANTENNA PATTERN
23, 25: METAL LAYER LAND PATTERN
27: RESIST INSULATING FILM
51: PRESS MEMBER

### MODE FOR CARRYING OUT THE INVENTION

In the following, embodiments of the present invention are described with reference to the accompanying drawings.

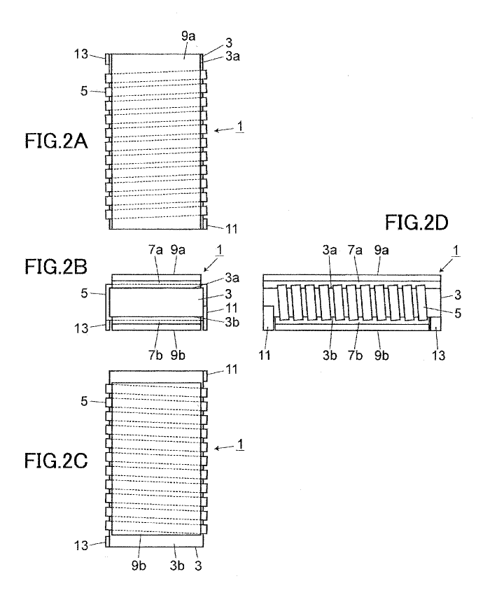

FIGS. 2A-2D are a front view, a top view, a rear view, and a right side view of a coil antenna according to an embodiment of the present invention.

In the present embodiment, a coil antenna 1 includes a core 3 that is plate-shaped and includes magnetic material, a coil wire 5, a first insulating layer 7a, a second insulating layer 7b, a first metal layer 9a, a second metal layer 9b, and coil antenna terminals 11, 13.

The coil wire 5 is wound around the core 3. The coil wire 5 may be mechanically wound on the core 3 or formed on the surface of the core 3 as a pattern through vapor deposition, for example. The first metal layer 9a is arranged on a surface 3a of the core 3 via the first insulating layer 7a. The second metal layer 9b is arranged on a rear face 3b of the core 3 via the second insulating layer 7b. As can be appreciated from FIGS. 2A-2D, the core 3 having the coil wire 5 wound thereon is interposed between the first and second metal layers 9a, 9b corresponding to two flat metal layers.

The coil antenna terminals 11, 13 are arranged at the sides of the core 3. The coil antenna terminal 11 is connected to one end of the coil wire 5, and the coil antenna terminal 13 is connected to the other end of the coil wire 5.

The surfaces of the first and second insulating layers 7a, 7b opposite the core 3 are arranged to be flat. The first and second insulating layers 7a, 7b may be made of insulating adhesive and may be arranged to have thicknesses in the range of 2-3 μm, for example.

The first and second metal layers 9a, 9b are arranged on the flat surfaces of the first and second insulating layers 7a, 7b. The first and second metal layers 9a, 9b are flat and are arranged to have substantially uniform thicknesses. For example, the first and second metal layers 9a, 9b may be made of a metal foil such as copper foil and may be arranged at a thickness of no more than 50 μm.

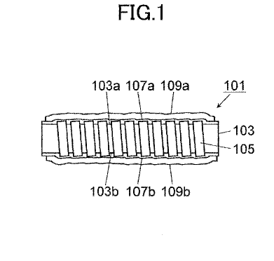

In the following, the communication distance of the coil antenna 1 according to the present embodiment is compared with the communication distance of the coil antenna 101 shown in FIG. 1.

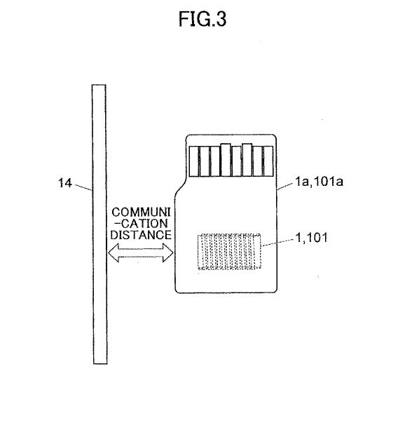

FIG. 3 is a diagram schematically illustrating a method used to measure the communication distance of the coil antenna 1 of the present embodiment and the coil antenna 101 of FIG. 1.

In FIG. 3, a first micro security digital card 1a having the coil antenna 1 embedded therein and a second micro security digital card 101a having the coil antenna 101 embedded therein are placed near an antenna 14. To measure the communication distance of the coil antenna 1 and the coil antenna 101, the distance between the antenna 14 and the first and second micro security digital cards 1a and 101a is gradually increased to determine the maximum distance from which the first and second micro security digital cards 1a, 101a may be able to establish communication with the antenna 14.

Table 1 shown below indicates the measurement results from measuring the communication distance of twelve samples of the coil antenna 1 of the present embodiment and twelve samples of the coil antenna 101 of FIG. 1.

TABLE 1

| | | Communication |
|---|---|---|
| | Sample No. | Distance (mm) |
| Metal Foil | 1 | 3.0 |
| Adhesion | 2 | 3.0 |
| Inadequate | 3 | 3.0 |
| (Coil Antenna | 4 | 3.0 |
| 101) | 5 | 6.0 |
| | 6 | 3.0 |
| | 7 | 3.0 |
| | 8 | 3.0 |
| | 9 | 1.0 |
| | 10 | 5.0 |
| | 11 | 8.0 |
| | 12 | 6.0 |
| | Average | 3.9 |
| Metal Foil | 13 | 12.0 |
| Adhesion Adequate | 14 | 11.0 |
| (Coil Antenna 1) | 15 | 13.0 |
| | 16 | 11.0 |
| | 17 | 11.0 |
| | 18 | 11.0 |
| | 19 | 12.0 |
| | 20 | 12.0 |
| | 21 | 12.0 |
| | 22 | 13.0 |
| | 23 | 12.0 |
| | 24 | 11.0 |
| | Average | 11.8 |

As is shown in Table 1, the average communication distance of the coil antenna 1 of the present embodiment was 11.8 mm. The average communication distance of the coil antenna 101 of FIG. 1 was 3.9 mm.

As can be appreciated from the above measurement results, greater communication distance may be obtained by the coil antenna 1 of the present embodiment compared to the coil antenna 101 of FIG. 1. Further, a relatively constant communication distance may be obtained by the coil antenna 1 of the present embodiment compared to the coil antenna 101 of FIG. 1.

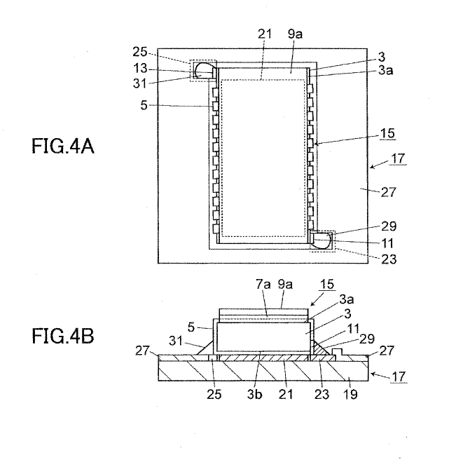

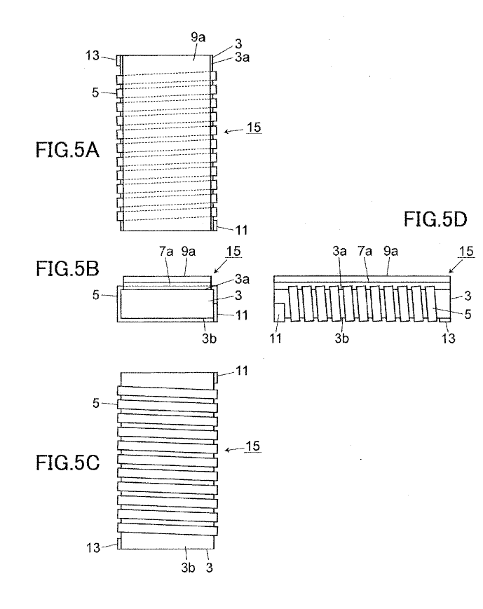

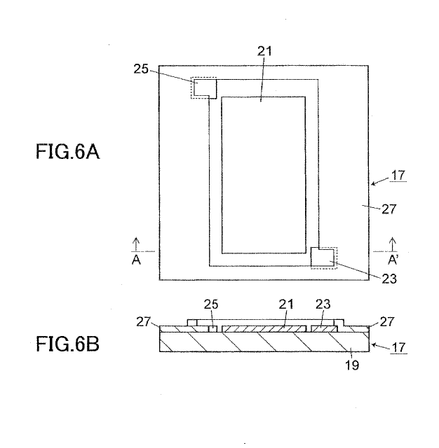

FIGS. 4A and 4B are a top view and a front view of a coil antenna-mounted structure according to an embodiment of the present invention. FIGS. 5A-5D are a front view, a top view, a rear view, and a right side view of a coil antenna used in the present embodiment. FIGS. 6A and 6B are a top view and a cross-sectional view of a mounting substrate used in the present embodiment. It is noted that FIG. 6B shows a cross-sectional view from section A-A′ of FIG. 6A. FIG. 4B shows the cross-sectional view of the mounting substrate of FIG. 6B. In the following, features of the present embodiment that are identical to FIGS. 2A-2D are given the same reference numerals and their descriptions are omitted.

The coil antenna-mounted structure shown in FIGS. 4A and 4B includes a coil antennal 15 and a mounting substrate 17.

The coil antenna 15 includes the core 3, the coil wire 5, the insulating layer 7a, the metal layer 9a, and the coil antenna terminals 11, 13. The coil antenna terminals 11, 13 are arranged at the side faces of the core 3. It is noted that the coil antenna 15 of the present embodiment does not include the second insulating layer 7b and the second metal layer 9b of the coil antenna 1 shown in FIGS. 2A-2D.

The mounting substrate 17 may be a printed circuit board having an insulating base material 19 on which metal layer patterns 21, 23, 25 and a resist insulating film 27 are arranged in this order. The metal layer patterns 21, 23, 25 may have thicknesses in the range of 30-50 μm, for example. It is noted that the insulating base material 19 may have other metal layer patterns (i.e., patterns other than the metal layer patterns 21, 23, 25) arranged at locations other than the coil antenna 15 mounting location.

The metal layer pattern 21 is a flat metal layer antenna pattern that is arranged to face the coil antenna 15 when the coil antenna 15 is mounted on the mounting substrate 17.

The metal layer patterns 23, 25 are metal layer land patterns arranged to face the coil antenna terminals 11, 13.

The resist insulating film 27 is removed from the coil antenna 15 mounting location including the location where the metal layer antenna pattern 21 is arranged. The resist insulating film 27 is also removed from the location where the metal layer land patterns 23, 25 are arranged. The resist insulating film 27 may have a thickness in the range of 10-30 μm, for example.

The coil antenna 15 has the rear face 3b that is mounted on the mounting substrate 17. The coil antenna terminal 11 and the metal layer land pattern 23 are bonded by solder 29. The coil antenna terminal 13 and the metal layer land pattern 25 are bonded by solder 31. In this way, the mounting substrate 17 may be fixed to the coil antenna 15.

The coil wire 5 of the coil antenna 15 arranged on the rear face 3b of the core 3 comes into contact with the metal layer antenna pattern 21. It is noted that a thin insulating film (not shown) is arranged-on the surface of the coil wire 5. In this way, the coil wire 5 may be insulated from the metal layer antenna pattern 21.

According to one aspect of the present embodiment, the core 3 having the coil wire 5 wound thereon is interposed between the flat metal layer 9a and the flat metal layer antenna pattern 21 so that the communication distance may be improved in the coil antenna 15 compared to a coil antenna having a metal layer that is warped and/or uneven.

According to another aspect of the present embodiment, the resist insulating layer 27 is removed from the location where the metal layer antenna pattern 21 is arranged so that the distance between the coil antenna 15 and the metal layer antenna pattern 21 may be reduced compared to a coil antenna-mounted structure in which the resist insulating layer is not removed. In this way, the communication distance of the coil antenna 15 may be further improved.

According to another aspect of the present embodiment, since the coil antenna terminals 11, 13 are arranged at the side faces of the core 3, and the solders 29, 31 are not arranged at the rear face 3b side of the core 3, the distance between the coil antenna 15 and the metal layer antenna pattern 21 may be reduced compared to a coil antenna-mounted structure in which solder is arranged at the rear face side of the core. In this way, the communication distance of the coil antenna 15 may be further improved.

In another embodiment, the coil antenna 15 may have the coil antenna terminals 11, 13 arranged at the side faces and the rear face of the core 3.

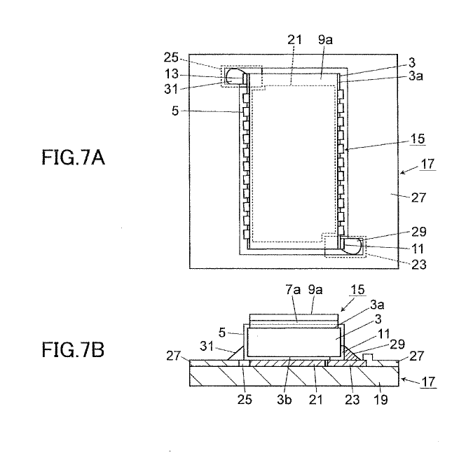

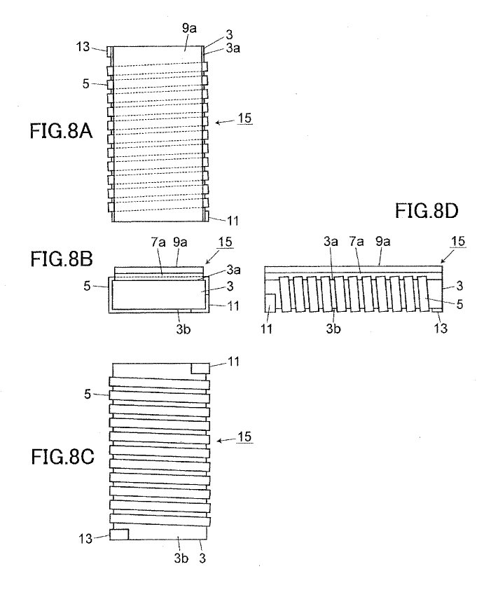

FIGS. 7A and 7B are a top view and a front view of a coil antenna-mounted structure according to another embodiment of the present invention. FIGS. 8A-8D are a front view, a top view, a rear view, and a right side view of a coil antenna used in the coil antenna-mounted structure according to the present embodiment.

In the coil antenna-mounted structure according to the present embodiment, the coil antenna terminals 11, 13 are arranged at the side faces and the rear face 3b of the core 3.

When the coil antenna 15 is mounted on the mounting substrate 17, the solders 29, 31 are bonded to the side faces of the coil antenna terminals 11, 13. It is noted that the solders 29, 30 are not arranged on the rear face 3b of the core 3.

According to an aspect of the present embodiment, since the solders 29, 31 are not arranged on the rear face 3b of the core 3, the distance between the coil antenna 15 and the metal layer antenna pattern 21 may be reduced compared to a coil antenna-mounted structure in which solder is arranged on the rear face of the core. In turn, the communication distance of the coil antenna 15 may be improved.

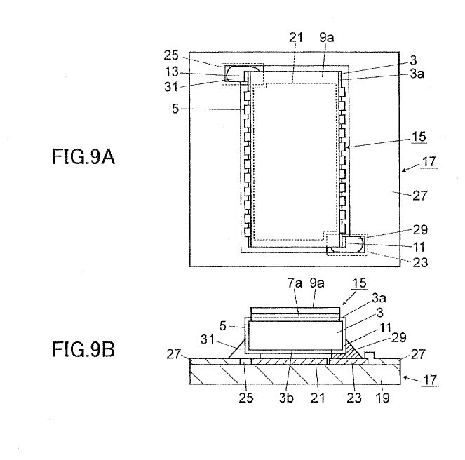

FIGS. 9A and 9B are a top view and a front view of a coil antenna-mounted structure according to another embodiment of the present invention.

In the coil antenna-mounted structure according to the present embodiment, the solders 29, 31 are bonded to the side faces and bottom faces of the coil antenna terminals 11, 13. It is noted that other features of the present embodiment may be identical to those of the coil antenna-mounted structure shown in FIGS. 7A and 7B.

According to an aspect of the present embodiment, since the core 3 having the coil wire 5 wound thereon is interposed between the flat metal layer 9a and the flat metal layer antenna pattern 21, the communication distance of the coil antenna 15 may be improved compared to a coil antenna having a metal layer that is warped and/or uneven.

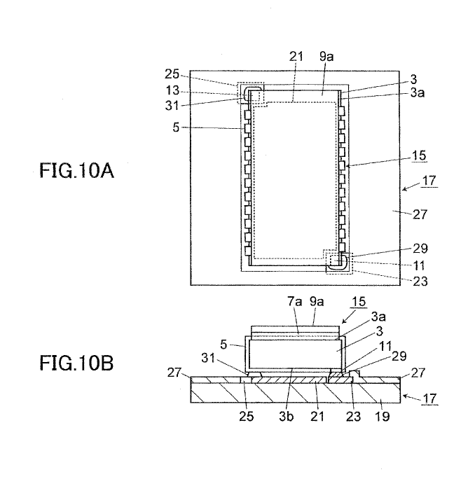

FIGS. 10A and 10B are a top view and a front view of a coil antenna-mounted structure according to another embodiment of the present invention.

In the coil antenna-mounted structure according to the present embodiment, the coil antenna 15 has the coil antenna terminals 11, 13 arranged at the rear face 3b of the core 3. The solders 29, 31 are bonded to the rear faces of the coil antenna terminals 11, 13. It is noted that other features of the present embodiment may be identical to those of the coil antenna-mounted structure shown in FIGS. 9A and 9B.

According to an aspect of the present embodiment, since the core 3 having the coil wire 5 wound thereon is interposed between the flat metal layer 9a and the flat metal layer antenna pattern 21, the communication distance of the coil antenna 15 may be improved compared to a coil antenna having a metal layer that is warped and/or uneven.

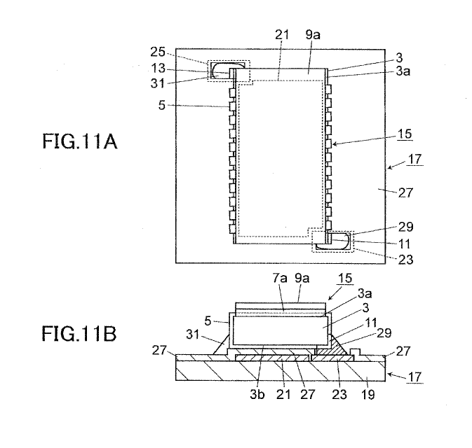

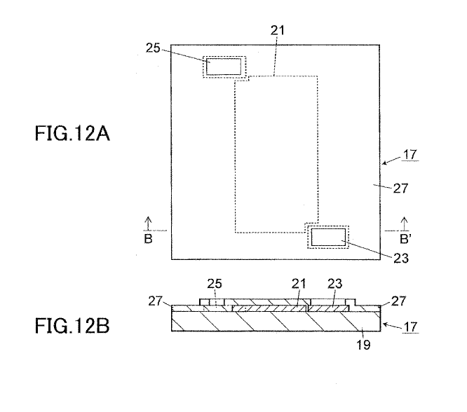

FIGS. 11A and 11B are a top view and a front view of a coil antenna-mounted structure according to another embodiment of the present invention. FIGS. 12A and 12B are a top view and a cross-sectional view of a mounting substrate used in the present embodiment. It is noted that FIG. 12B is a cross-sectional view from section B-B′ of FIG. 12A, and the front view of the coil antenna-mounted structure of FIG. 11B shows the cross-sectional view of the mounting substrate shown in FIG. 12B.

In the coil antenna-mounted structure according to the present embodiment, the mounting substrate 17 has the metal layer antenna pattern 21 covered by the resist insulating film 27. It is noted that other features of the present embodiment may be identical to those of the coil antenna-mounted structure shown in FIGS. 9A and 9B.

According to an aspect of the present embodiment, since the core 3 having the coil wire 5 wound thereon is interposed between the flat metal layer 9a and the flat metal layer antenna pattern 21, the communication distance of the coil antenna 15 may be improved compared to a coil antenna having a metal layer that is warped and/or uneven.

It is noted that in the coil antenna-mounted structure of FIGS. 11A and 11B, the coil antenna terminals 11, 13 are arranged on the side faces and rear face 3b of the core 3. However, in another embodiment, the coil antenna terminals 11, 13 may only be arranged on the side faces of the core 3. In yet another embodiment, the coil antenna terminals 11, 13 may only be arranged on the rear face 3b of the core 3.

In the above embodiments of the coil antenna-mounted structure, the planar size of the metal layer antenna pattern 21 is arranged to be smaller than the planar size of the coil antenna 15. However, in other embodiments of the present invention, the planar size of the metal layer antenna pattern may be larger than the planar size of the coil antenna.

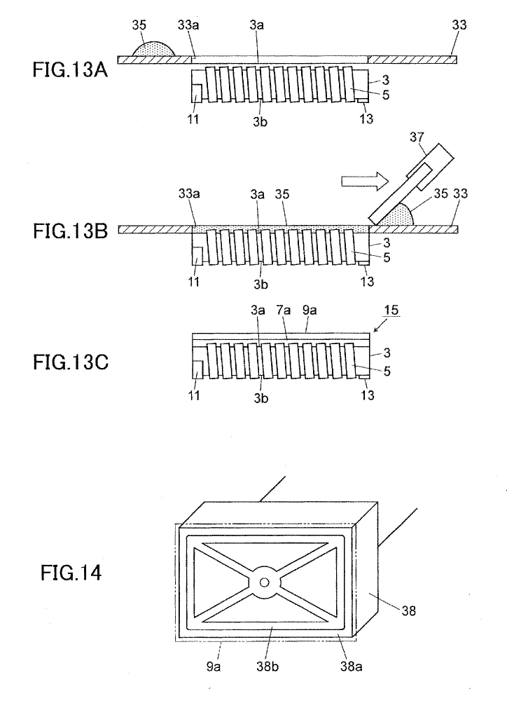

FIGS. 13A-13C are schematic side views illustrating exemplary process steps for manufacturing a coil antenna according to an embodiment of the present invention. It is noted that features of the coil antenna shown in FIGS. 13A-13C that are identical to those shown in FIGS. 5A-5D are given the same reference numerals.

In FIG. 13A, a screen mask 33 having an opening portion 33a for the insulating layer 7a (shown in FIGS. 5B and 5D) is arranged on the surface 3a of the core 3 having the coil wire 5 wound thereon in a manner such that the opening portion 33a is positioned at a location where the insulating layer 7a is to be arranged. Then, an insulating adhesive 35 is arranged on the screen mask 33. The insulating adhesive 35 may be an adhesive for electronic materials such as Carbodilite (registered trademark of Nisshinbo Chemical Inc.) CAF-F4, for example.

In FIG. 13B, the insulating adhesive 35 is supplied in the opening 33a by moving a squeegee 37 on the screen mask 33. The insulating adhesive 35 supplied in the opening 33a is discharged from the opening 33a towards the core 3. In this way, the insulating adhesive 35 arranged on the surface 3a of the core 3 may have a flat surface.

In FIG. 13C, the screen mask 33 is removed. Then, a metal layer 9a, which may be made of a metal foil having a substantially uniform thickness, for example, is arranged on the flat surface of the insulating adhesive 35 that is arranged on the surface 3a of the core 3. The insulating adhesive 35 forms the insulating layer 7a. In this way, a coil antenna 15 having a flat metal layer 9a arranged on the surface 3a of the core 3 may be created.

FIG. 14 is a perspective view of an exemplary jig used to transport the metal layer 9a.

A metal foil suction jig 38 shown in FIG. 14 includes a flat suction surface 38a to which the metal layer 9a made of metal foil is suctioned. The area of the suction surface 38a may be 90-100% of the area of the metal layer 9a. A suction groove 38b is arranged at the suction surface 38a.

The suction groove 38b includes a circular portion arranged at the center of the suction surface 38a, a frame portion arranged around the periphery of the suction surface 38a, and linear portions extending from the four corners of the frame portion towards the circular portion.

With such an arrangement, warping of the metal layer 9a may be prevented when the metal layer 9a is suctioned by the suction jig 38. It is noted that the jig used for transporting the metal layer 9a is not limited to the metal foil suction jig 38 described above.

The coil antenna 15 having the flat metal layer 9a arranged on the surface 3a of the core 3 created by the process steps of FIGS. 13A-13C may be used in a coil antenna-mounted structure according to an embodiment of the present invention such as the coil antenna-mounted structures shown in FIGS. 4A-4B, 7A-7B, 9A-9B, 10A-10B, and 11A-11B.

It is noted that the process steps described in FIGS. 13A-13C may be performed on the rear face 3b of the coil antenna 15. In this way, a coil antenna having a core interposed between two flat metal layers such as the coil antenna 1 shown in FIGS. 2A-20 may be created.

In other embodiments, non-conductive paste rather than an insulating adhesive may be used to create the insulating layer 7a and a metal paste such as silver paste rather than a metal foil may be used to create the metal layer 9a. It is noted that these alternative materials may also be used to create a flat insulating layer 7a and a flat metal layer 9a on the surface 3a of the core 3.

In the case of using a non-conductive paste as the material for the insulating layer 7a, the non-conductive paste may be used to create the insulating layer 7a having a flat surface opposite the core 3 in a manner similar to the case of using the insulating adhesive 35.

In the case of using a metal paste as the material for the metal layer 9a, the metal paste may be used to create the metal layer 9a that is flat and substantially uniform in thickness on the flat surface of the insulating layer 7a without involving mechanical transportation. That is, the metal layer 9a is not mechanically transported to the core 3 from a separate location. In the case of using a metal foil or a metal plate that is pre-fabricated, the metal foil or the metal plate is mechanically transported and placed on the core 3.

When the metal foil or metal plate is mechanically transported, the metal foil or metal plate may be damaged from loosening, warping, or scratching, for example. Such problems may be avoided by creating the metal layer 9a through screen printing using a metal paste, for example.

It is noted that in FIGS. 13A-13C, the coil antenna terminals 11, 13 are arranged on the side faces of the core 3. However, the arrangement positions of the coil antenna terminals 11, 13 are not limited to this illustrated example, and the coil antenna terminals 11, 13 may in fact be arranged at any position. It is further noted that the same applies to the coil antenna manufacturing methods according to other embodiments of the present invention described below.

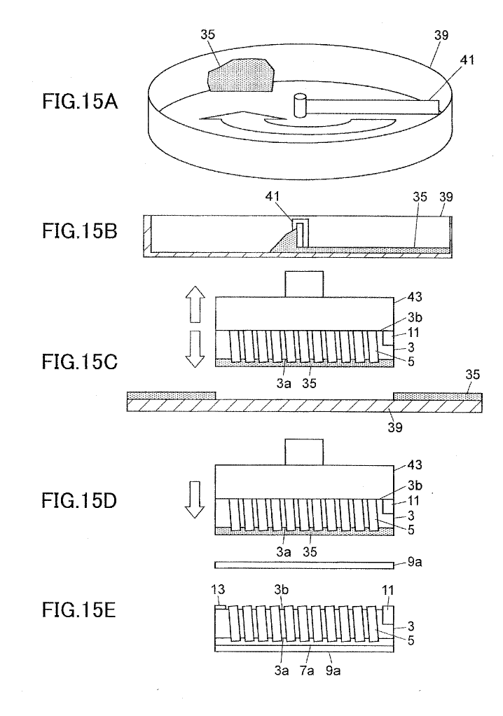

FIGS. 15A-15E are a perspective view and side views illustrating exemplary process steps for manufacturing a coil antenna according to another embodiment of the present invention. It is noted that features of the coil antenna shown in FIGS. 15A-15E that are identical to those shown in FIGS. 5A-5D are given the same reference numerals.

In FIG. 15A, the insulating adhesive 35 is deposited in a circular stage 39 and a squeegee 41 attached to the center of the stage 39 is rotated.

In FIG. 15B, through the rotation of the squeegee 41, the insulating adhesive 35 is arranged to have a substantially uniform thickness within the space beneath the squeegee 41.

In FIG. 15C, the rear face 3b of the core 3 having the coil wire 5 wound thereon is suctioned to a suction collet 43. The suction collet 43 is then moved and the surface 3a of the core 3 is pressed to the insulating adhesive 35 that is arranged to have a substantially uniform thickness. In this way, the insulating adhesive 35 with a flat surface may be arranged on the surface 3a of the core 3.

In FIG. 15D, the collet 43 is moved and a metal layer 9a, which may be made of a metal foil having a substantially uniform thickness, for example, is bonded to the flat surface of the insulating adhesive 35.

In FIG. 15E, the core 3 is removed from the collet 43 and the insulating adhesive 35 forms the insulating layer 7a. In this way, a flat metal layer 9a may be arranged on the surface 3a of the core 3.

The coil antenna 15 having the flat metal layer 9a arranged on the surface 3a of the core 3 created by the process steps of FIGS. 15A-15S may be used in a coil antenna-mounted structure according to an embodiment of the present invention such as the coil antenna-mounted structures shown in FIGS. 4A-4B, 7A-7B, 9A-9B, 10A-10B, and 11A-11B.

It is noted that the process steps described in FIGS. 15A-15E may be performed on the rear face 3b of the coil antenna 15. In this way, a coil antenna having a core interposed between two flat metal layers such as the coil antenna 1 shown in FIGS. 2A-2D may be created.

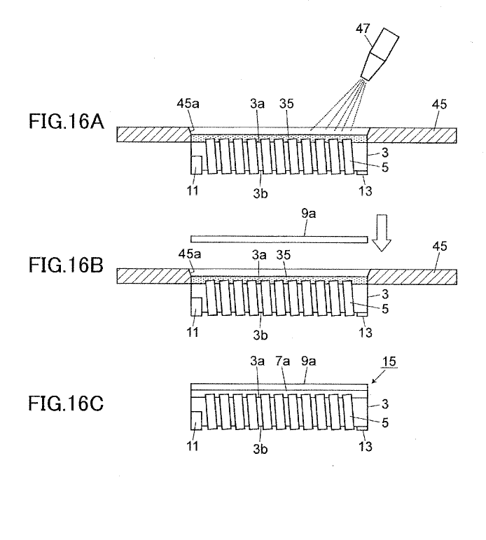

FIGS. 16A-16C are schematic side views illustrating exemplary process steps for manufacturing a coil antenna according to another embodiment of the present invention. It is noted that features of the coil antenna shown in FIGS. 16A-16C that are identical to those shown in FIGS. 5A-5D are given the same reference numerals.

In FIG. 16A, a mask 45 having an opening portion 45a for the insulating layer 7a (shown in FIGS. 5B and 5D) is arranged on the surface 3a of the core 3 having the coil wire 5 wound thereon in a manner such that the opening portion 45a is positioned at a location where the insulating layer 7a is to be arranged. Then, a predetermined amount of insulating adhesive is sprayed towards the opening portion 45a from a spray nozzle 47. In this way, insulating adhesive 35 covering the coil wire 5 is formed on the surface 3a of the core 3 within the opening portion 45a. It is noted that an insulating adhesive with adequate viscosity is desirably used such that the insulating adhesive 35 supplied in the opening portion 45a may form a flat surface. The insulating adhesive 35 supplied in the opening portion 45a is thus arranged to have a flat surface opposite the core 3.

In FIG. 16B, a metal layer 9a, which may be made of a metal foil having a substantially uniform thickness, for example, is transported through the opening portion 45a of the mask 45 to be arranged on the flat surface of the insulating adhesive 35 that is formed on the surface 3a of the core 3. It is noted that the metal foil suction jig 38 shown in FIG. 14 may be used to transport the metal layer 9a, for example.

In FIG. 16C, the mask 45 is removed and the insulating adhesive 35 forms the insulating layer 7a. In this way, a coil antenna 15 having a flat metal layer 9a arranged on the surface 3a of the core 3 may be created.

The coil antenna 15 having the flat metal layer 9a arranged on the surface 3a of the core 3 created by the process steps of FIGS. 16A-16C may be used in a coil antenna-mounted structure according to an embodiment of the present invention such as the coil antenna-mounted structures shown in FIGS. 4A-4B, 7A-7B, 9A-9B, 10A-10B, and 11A-11B.

It is noted that the process steps described in FIGS. 16A-16C may be performed on the rear face 3b of the coil antenna 15. In this way, a coil antenna having a core interposed between two flat metal layers such as the coil antenna 1 shown in FIGS. 2A-2D may be created.

While preferred embodiments of a method of manufacturing a coil antenna according to one aspect of the present invention have been described above, the present invention is not limited to these embodiments.

For example, a method of manufacturing a coil antenna according to an embodiment of the present invention may use any process to perform the step of arranging an insulating layer on a surface of the core in a manner such that the insulating layer covers the coil wire and has a flat surface opposite the surface of the core.

Also, a method of manufacturing a coil antenna according to an embodiment of the present invention may use any process to perform the step of arranging a flat metal layer on the flat surface of the insulating layer.

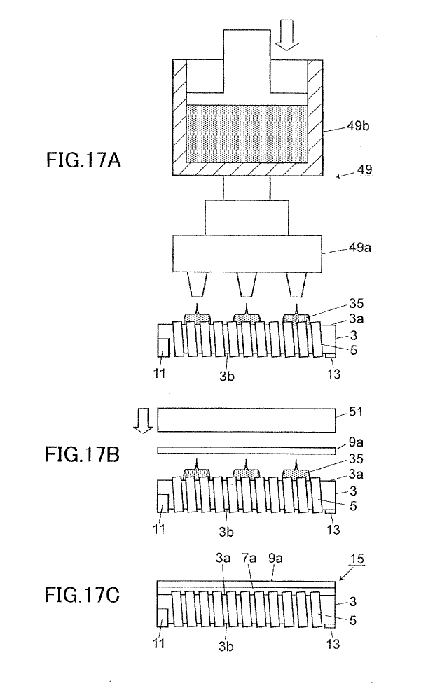

FIGS. 17A-17C are schematic side views illustrating exemplary process steps for manufacturing a coil antenna according to another embodiment of the present invention. It is noted that features of the coil antenna shown in FIGS. 17A-17C that are identical to those shown in FIGS. 5A-5D are given the same reference numerals.

In FIG. 17A, a predetermined amount of the insulating adhesive 35 is dropped on the surface 3a of the core 3 having the coil wire 5 wound thereon. The insulating adhesive 35 may be dropped on the surface 3a of the core 3 using a dispenser 49, for example. However, other devices or methods may be used to drop a predetermined amount of the insulating adhesive 35 as well.

The dispenser 49 includes a porous nozzle 49a and a syringe pump 49b.

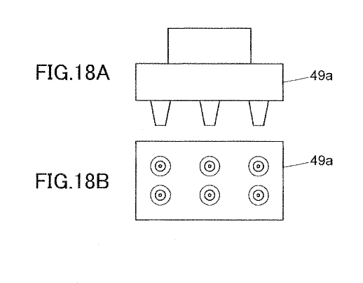

FIGS. 18A and 18B are a front view and a bottom view of the porous nozzle 49a.

By driving a plunger of the syringe pump 49b that is connected to the porous nozzle 49a, the insulating adhesive 35 may be pushed out of the porous nozzle 49a at a certain pressure. In this way, plural drops of the insulating adhesive in substantially uniform amounts may be simultaneously applied on the surface 3a of the core 3.

In FIG. 17B, a metal layer 9a, which may be made of a metal foil having a substantially uniform thickness, for example, is placed on the insulating adhesive 35 that has been applied on the surface 3a of the core 3. Then, a press member 51 having a flat surface that is parallel to the surface 3a of the core 3 is arranged on the metal layer 9a. The metal layer 9a is pressed towards the core 3 by the press member 51 at a predetermined pressure.

As is shown in FIG. 17C, the insulating adhesive 35 is pressed and spread across the surface 3a of the core 3 by the flat metal layer 9a. The insulating adhesive 35 thus forms an insulating layer 7a that covers the coil wire 5 and has a flat surface opposite the core 3. The flat metal layer 9a is arranged on the flat surface of the insulating layer 7a.

The coil antenna 15 having the flat metal layer 9a arranged on the surface 3a of the core 3 created by the process steps of FIGS. 17A-17C may be used in a coil antenna-mounted structure according to an embodiment of the present invention such as the coil antenna-mounted structures shown in FIGS. 4A-4B, 7A-7B, 9A-9B, 10A-10B, and 11A-11B.

It is noted that the process steps described in FIGS. 17A-17C may be performed on the rear face 3b of the coil antenna 15. In this way, a coil antenna having a core interposed between two flat metal layers such as the coil antenna 1 shown in FIGS. 2A-2D may be created.

While a preferred embodiment of a method of manufacturing a coil antenna according to another aspect of the present invention has been described above, the present invention is not limited to this embodiment.

For example, a method of manufacturing a coil antenna according to an embodiment of the present invention may use any process to perform the step of dropping a predetermined amount of insulating adhesive on a surface of the core.

Also, a method of manufacturing a coil antenna according to an embodiment of the present invention may use any process to perform the step of arranging a metal layer having a substantially uniform thickness on the insulating adhesive, pressing the metal layer towards the core using a press member having a flat surface that is parallel to the surface of the core, creating an insulating layer from the insulating adhesive by arranging the insulating adhesive on the surface of the core to cover the coil wire and have a flat surface opposite the core, and arranging the flat metal layer to be flat on the flat surface of the insulating layer.

A method of manufacturing a coil antenna-mounted structure according to an embodiment of the present invention may use a coil antenna 15 that has a flat metal layer 9a arranged on the surface 3a of the core 3 and a mounting substrate 17 that has a flat metal layer antenna pattern 21 arranged at the mounting location of the coil antenna 15 (see FIGS. 4A-4B, 7A-7B, 9A-9B, 10A-10B, and 11A-11B). In this embodiment, the coil antenna 15 is mounted on the mounting substrate 17 in a manner such that the rear face 3b of the core 3 opposite the surface 3a on which the metal layer 9a is arranged faces the metal layer antenna pattern 21.

Further, the present invention is not limited to these embodiments, and numerous variations and modifications may be made without departing from the scope of the present invention.

The present application is based on and claims the benefit of the priority date of Japanese Patent Application No. 2011-242592 filed on Nov. 4, 2011 with the Japanese Patent Office, the entire contents of which are hereby incorporated by reference.

1. A coil antenna-mounted structure comprising:
a coil antenna having a core that is plate-shaped and includes a magnetic material and a coil wire that is wound around the core; and
a mounting substrate on which the coil antenna is mounted;
wherein the coil antenna includes an insulating layer having a flat surface and a flat metal layer that is arranged on the flat surface of the insulating layer, the insulating layer being arranged on a surface of the core opposite the mounting substrate to cover the coil wire; and
the mounting substrate includes a flat metal layer antenna pattern that is arranged at a location facing the coil antenna.

2. The coil antenna-mounted structure as claimed in claim 1, wherein
the mounting substrate includes an insulating base material on which a metal layer pattern including the metal layer antenna pattern and a resist insulating film are arranged; and
the resist insulating film is removed from a location of the metal layer antenna pattern.

3. The coil antenna-mounted structure as claimed in claim 1, wherein
the coil antenna includes a coil antenna terminal that is arranged at a side face of the core;
the mounting substrate includes a metal layer land pattern arranged at a location of the coil antenna terminal; and
the coil antenna terminal and the metal layer land pattern are bonded by solder.

4. A coil antenna comprising:
a core that is plate-shaped and includes a magnetic material;
a coil wire that is wound around the core;
a first insulating layer that is arranged on a surface of the core, the insulating layer being arranged to cover the coil wire and have a flat surface opposite the core;
a second insulating layer that is arranged on a rear face opposite the surface of the core, the second insulating layer being arranged to cover the coil wire and to have a flat surface opposite the core;
a flat first metal layer arranged on the flat surface of the first insulating layer; and
a flat second metal layer arranged on the flat surface of the second insulating layer.

5. A method of manufacturing a coil antenna having a core that is plate-shaped and includes magnetic material and a coil wire that is wound around the core, the method comprising the steps of:
arranging an insulating layer on a surface of the core, the insulating layer being arranged to cover the coil wire and to have a flat surface opposite the surface of the core; and
arranging a flat metal layer on the flat surface of the insulating layer.

6. The method of manufacturing a coil antenna as claimed in claim 5, wherein
the step of arranging the insulating layer includes applying an insulating adhesive on the surface of the core using a screen printing method and creating the insulating layer from the insulating adhesive.

7. The method of manufacturing a coil antenna as claimed in claim 5, wherein
the step of arranging the insulating layer includes arranging an insulating adhesive to have a substantially uniform thickness, pressing the surface of the core onto the insulating adhesive, transferring the insulating adhesive onto the surface of the core, and creating the insulating layer from the insulating adhesive.

8. The method of manufacturing a coil antenna as claimed in claim 5, wherein
the step of arranging the insulating layer includes spraying an insulating adhesive on the surface of the core and creating the insulating layer from the insulating adhesive.

9. The method of manufacturing a coil antenna as claimed in claim 5, further comprising:
performing the step of arranging the insulating layer and the step of arranging the metal layer on a rear face opposite the surface of the core.

10. The method of manufacturing a coil antenna as claimed in claim 5, wherein the steps of arranging the insulating layer and arranging the flat metal layer include
dropping a predetermined amount of insulating adhesive on a surface of the core; and
arranging a metal layer having a substantially uniform thickness on the insulating adhesive, pressing the metal layer towards the core using a press member having a flat surface that is parallel to the surface of the core, creating the insulating layer from the insulating adhesive by arranging the insulating adhesive on the surface of the core to cover the coil wire and have a flat surface opposite the core, and arranging the metal layer to be flat on the flat surface of the insulating layer.

11. The method of manufacturing a coil antenna as claimed in claim 10, further comprising:
performing the step of dropping the insulating adhesive and the step of arranging the metal layer on a rear face opposite the surface of the core.

12. The method of manufacturing a coil antenna as claimed in claim 5, further comprising the step of:
mounting the coil antenna on a mounting substrate, the mounting substrate having a metal layer antenna pattern arranged at a mounting location of the coil antenna;
wherein the metal layer antenna pattern is arranged to face a rear face of the core opposite the surface on which the flat metal layer is arranged.

13. The coil antenna-mounted structure as claimed in claim 2, wherein
the coil antenna includes a coil antenna terminal that is arranged at a side face of the core;
the mounting substrate includes a metal layer land pattern arranged at a location of the coil antenna terminal; and
the coil antenna terminal and the metal layer land pattern are bonded by solder.

14. The method of manufacturing a coil antenna as claimed in claim 6, further comprising:
performing the step of arranging the insulating layer and the step of arranging the metal layer on a rear face opposite the surface of the core.

15. The method of manufacturing a coil antenna as claimed in claim 7, further comprising:
performing the step of arranging the insulating layer and the step of arranging the metal layer on a rear face opposite the surface of the core.

16. The method of manufacturing a coil antenna as claimed in claim 8, further comprising:
performing the step of arranging the insulating layer and the step of arranging the metal layer on a rear face opposite the surface of the core.
